(19) United States
(12) Patent Application Publication
(10) Pub. No.: US 2006/0260131 A1
(43) Pub. Date: Nov. 23, 2006

(54) Razor cartridge having a decoupled guard bar

(75) Inventor: Thomas A. Follo, Milford, CT (US)

Correspondence Address: MICHAUD-DUFFY GROUP LLP, 306 INDUSTRIAL PARK ROAD, SUITE 206, MIDDLETOWN, CT, 06457, US

(73) Assignee: Eveready Battery Company, Inc., St. Louis, MO (US)

(21) Appl. No.: 11/438,004

(22) Filed: May 19, 2006

Related U.S. Application Data
(60) Provisional application No. 60/683,521, filed on May 20, 2005.

(51) Int. Cl. B26B 21/22; B26B 21/52

(52) U.S. Cl. 30/50; 30/527

(57) ABSTRACT

According to the present invention, a shaving implement includes a handle, a neck, a razor cartridge, and a biasing member. The neck extends from the handle and includes a first connecting member and a guard bar having a skin-engaging surface. The razor cartridge includes a cap positioned aft of the at least one blade. The razor cartridge is attached to the first connecting member of the neck such that the razor cartridge is pivotable relative to the skin-engaging surface of the guard bar between a neutral position and a rotated position. A biasing member urges the razor cartridge toward the neutral position. During use, the frictional forces caused by the surface being shaved passing over the skin-engaging surface of the guard bar are transferred into the handle, and, therefore, have a negligible effect on the pivotal movement of the razor cartridge between the neutral and rotated positions during normal shaving.

### CROSS REFERENCE TO RELATED APPLICATION

This application claims the benefit of U.S. Provisional Patent Application No. 60/683,521, filed on May 20, 2005, the contents of which are incorporated by reference in their entirety.

### BACKGROUND

1. Field of the Invention

The present invention is generally directed to razor cartridges and shaving implements employing razor cartridges in general, and to shaving implements employing a razor cartridge that pivots relative to a guard bar in particular.

2. Background of the Invention

Most prior art shaving implements, also commonly known as wet shave razors, include a razor cartridge and a handle. The razor cartridge typically includes at least one blade positioned aft of a guard bar and forward of a cap, as shown in FIG. 1. During use, the razor cartridge is pivotally mounted on a handle such that it can pivot relative to the handle between a neutral position and a rotated position. The razor cartridge is in the neutral position when fully rotated toward the surface to be shaved. The razor cartridge is in the rotated position when it is fully rotated away from the surface to be shaved. The pivoting action of the razor cartridge between the neutral and rotated positions relative to the handle is important because it enables the razor cartridge and its associated blade(s) to maintain contact with the surface being shaved.

During normal shaving, certain forces tend to cause the razor cartridge to pivot relative to the handle, away from the surface being shaved, and toward the rotated position. The above-mentioned forces primarily include the frictional forces caused by the surface being shaved passing over the guard bar, and the forces that result when the blade(s) cut hair. To compensate for the tendency of the cartridge to pivot away from the surface to be shaved, shaving implements often employ a biasing member, such as a spring-loaded plunger. The biasing member acts to urge the razor cartridge towards the neutral position, keeping the razor cartridge in contact with the surface to be shaved. FIG. 2 depicts a prior art shaving implement in contact with a surface, and indicates how the opposing forces created by the biasing member, guard bar, and razor blade(s) act on the razor cartridge.

During use, it is preferable that the razor cartridge is slightly pivoted relative to the handle to a position between the neutral and rotated positions. In the above-described position, the razor is able to pivot in both directions (i.e., toward the neutral position, or toward the rotated position). The ability to pivot in both directions enables the razor to maintain contact with the surface being shaved, even when passing over contours.

However, one difficulty with designing a biasing member is the fact that the above-described forces can vary greatly depending on, for example, how hard the user presses the razor cartridge against his or her skin, the amount of hair being removed, and the amount of water and/or shaving aid present. For example, in situations where the forces acting on the guard bar and razor blade(s) are relatively low, the forces exerted against the razor cartridge by the biasing member will prevent the razor cartridge from pivoting at all (i.e., the cartridge will remain in the neutral position). Conversely, relatively high forces acting on the razor blade(s), and especially those frictional forces acting on the guard bar, will cause the razor cartridge to pivot toward the rotated position. The latter situation, where the razor blade(s) may actually lose contact with the surface being shaved, is shown in FIG. 3. In both situations, the razor cartridge renders a poor quality shave.

Based on the foregoing, it is the general object of the present invention to provide a razor cartridge and a shaving implement that overcomes the problems and drawbacks associated with the prior art.

### SUMMARY OF THE INVENTION

According to the present invention, a shaving implement includes a handle, a neck, a razor cartridge, and a biasing member. The handle has a grip portion. The neck extends from the handle and includes a first connecting member and a guard bar. A skin-engaging surface is located on the guard bar. The razor cartridge includes a cap positioned aft of the at least one blade. The razor cartridge is attached to the first connecting member of the neck such that the razor cartridge is pivotable relative to the skin-engaging surface of the guard bar between a neutral position and a rotated position.

According to one aspect of the present invention, the razor cartridge described above further includes a rinse through member. The rinse through member is positioned forward of the at least one blade and is preferably substantially adjacent the skin-engaging surface of the guard bar. The rinse through member, as part of the razor cartridge, is also pivotable relative to the skin-engaging surface of the guard bar.

One advantage of the present invention is the fact that the guard bar is decoupled from the remaining aspects of the razor cartridge. Because the guard bar is decoupled from the razor cartridge, the forces acting on the guard bar during normal shaving are transferred into the handle during shaving, rather than acting to cause the razor cartridge to pivot away from the surface being shaved. Accordingly, the forces causing the razor cartridge to pivot away from the surface being shaved are essentially reduced to those caused by the one or more razor blades cutting hair. Thus, the range of forces against which the biasing member must overcome is reduced, and rendered more predictable. The resulting shaving implement of the present invention allows users to press as lightly or as firmly as desired during shaving without the razor cartridge undesirably rotating away from the surface being shaved, or remaining in the neutral position.

### BRIEF DESCRIPTION OF THE DRAWINGS

FIG. 1 is a prior art drawing of a conventional shaving implement;

FIG. 2 is a prior art drawing of a conventional shaving implement pressed against a surface to be shaved;

FIG. 3 is a prior art drawing of a conventional shaving implement that has rotated away from the surface being shaved during normal shaving;

FIG. 4 is an isometric view generally of the front of the shaving implement of the present invention;

FIG. 4A is an exploded view of the shaving implement of FIG. 4;

FIG. 4B is an isometric view generally of the rear of the shaving implement of the present invention;

FIG. 5 is a front view of the razor cartridge and neck of the present invention;

FIG. 6 is a side view of the razor cartridge and neck of the present invention in the neutral position;

FIG. 6A is a sectional view along line 6A-6A of the razor cartridge and neck of FIG. 5;

FIG. 7 is a side view of the razor cartridge and neck of the present invention in the rotated position;

FIG. 7A is a sectional view along line 7A-7A of the razor cartridge and neck of FIG. 5;

FIG. 8 is an isometric view of the razor cartridge of the present invention;

FIG. 8A is an isometric view of the razor cartridge of the present invention, wherein the cartridge includes a rinse through member;

FIG. 9 is a schematic of a razor cartridge having a rinse through member in the neutral position, wherein the rinse through member is above the shave plane;

FIG. 9A is a schematic of a razor cartridge having a rinse through member in a rotated position, wherein the rinse through member is above the shave plane;

FIG. 10 is a schematic of a razor cartridge having a rinse through member in the neutral position, wherein the rinse through member is substantially coincident with the shave plane;

FIG. 10A is a schematic of a razor cartridge having a rinse through member in the rotated position, wherein the rinse through member is substantially coincident with the shave plane;

FIG. 11 is a schematic of a razor cartridge having a rinse through member in the neutral position, wherein the rinse through member is below the shave plane; and

FIG. 11A is a schematic of a razor cartridge having a rinse through member in a rotated position, wherein the rinse through member is below the shave plane.

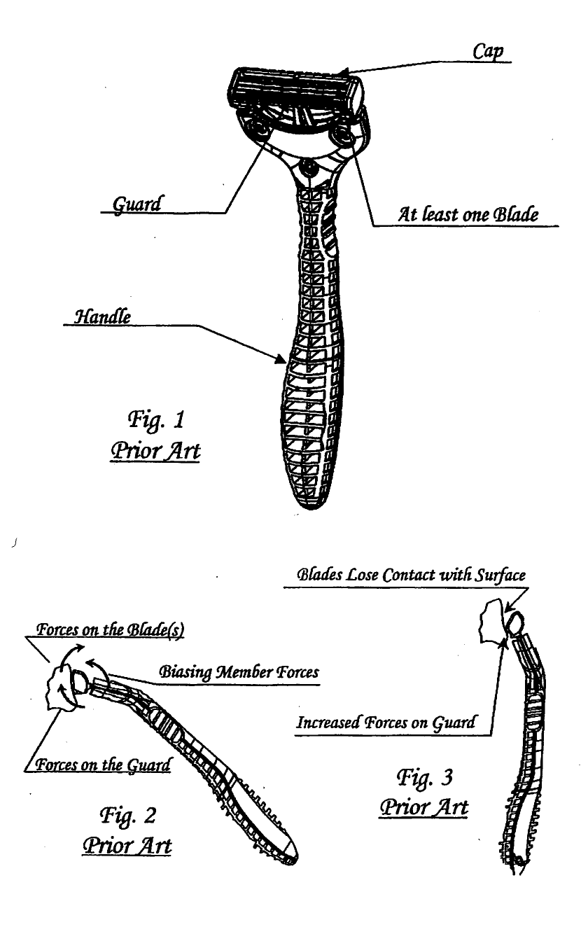

### DETAILED DESCRIPTION OF THE INVENTION

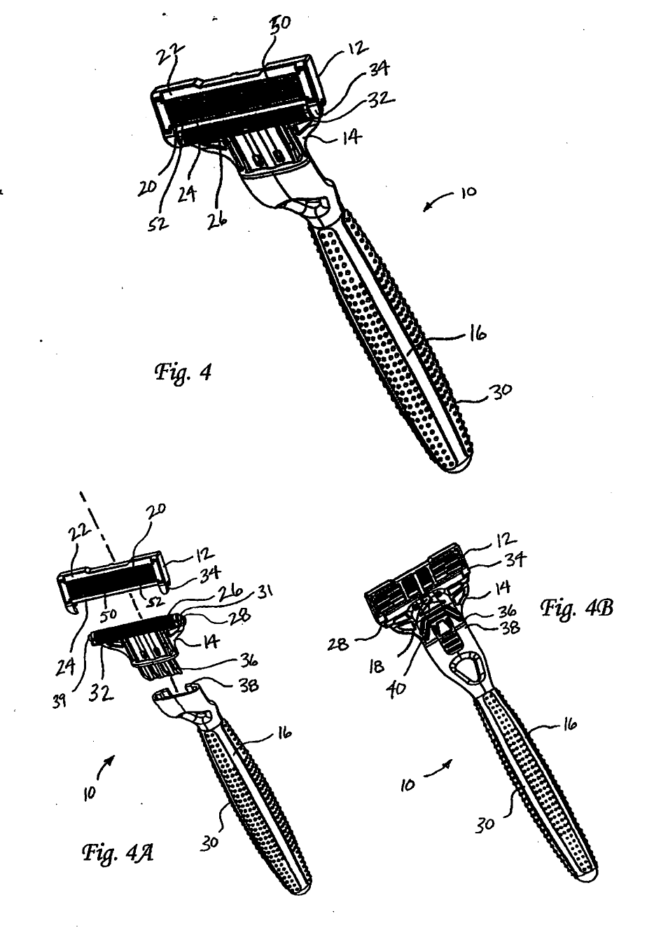

As shown in FIGS. 4-4B, the shaving implement 10 of the present invention includes a razor cartridge 12, a neck portion 14, a handle 16, and a biasing member 18. The razor cartridge 12 includes at least one blade 20, a cap 22, and, optionally, a rinse through member 24. The neck portion 16 includes a guard bar 26 and a first connecting member 28. The handle 16 includes a grip portion 30. The razor cartridge 12 is pivotally attached to the first connecting member 28 of the neck portion 16.

Shaving implements 10, also often referred to as wet shave razors, are typically sold commercially in two manners: as a “system”, or as a “disposable”. System razors typically include a permanent handle 16 and a detachable razor cartridge 12. In these situations, the razor cartridge 12 is removably attached to the handle 16 and used until the blade(s) 20 are dulled. Once the blade(s) 20 are worn, the user can selectively detach the razor cartridge 12 and replace it on the same handle 16 with a new razor cartridge 12. When the present invention is designed as a “system”, the neck portion 14 may be included as part of the permanent handle 16 (i.e., extending from the grip portion 30 of the handle 16), assembled as part of a replaceable razor cartridge 12, or manufactured separate from both the razor cartridge 12 and the handle 16. When the present razor is intended to be a disposable shaving implement 10, all three (3) segments 12,14,16 are typically attached such that they are not intended to be separable during normal use. In these situations, the disposable shaving implement 10 is used until the blades 20 are worn and then the entire shaving implement 10 is discarded. The present invention is discussed below in terms of both types of shaving implements 10.

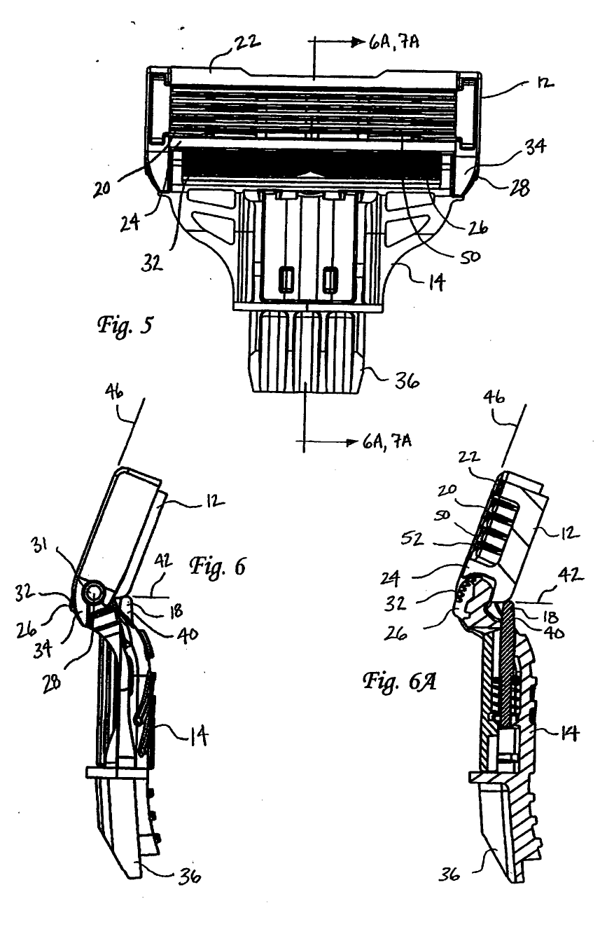

Referring to FIGS. 5-6A, the neck 14 includes a guard bar 26, and a first connecting member 28. The guard bar 26 includes a skin-engaging surface 32 that is operable to pre-stretch the skin of the surface being shaved prior to the surface encountering the at least one blade 20. The skin-engaging surface 32 may be made of any suitable material such as, but not limited to, an elastomeric material. The skin-engaging surface 32 can, for example, be injection molded directly onto the guard bar 26 of the neck portion 14. Preferably, the skin-engaging surface 32 of the guard bar 26 is curved, as is shown in FIG. 6A.

The first connecting member 28 pivotally attaches with complimentary connectors 34 on the razor cartridge 12 (discussed infra.). Any suitable connectors may be used as first connecting members 28 that provide a pivotal connection between the neck 14 and the razor cartridge 12. For example, as shown in FIG. 6, the first connecting member 28 includes two outwardly facing pins 31. Although the first connecting members 28 shown are “male”, they could likewise be “female” connectors that mate with complementary “male” connectors on the razor cartridge. In addition, although FIG. 5 shows the neck 14 having a first connecting member 28 with two (2) connection points (see also FIG. 4A), one (1) or three (3), or more connection points may also be utilized with departing from the scope of the present invention. In all embodiments, however, it is preferable that none of the connection points of the first connecting member 28 impede the surface being shaved from contacting the skin-engaging surface during normal shaving. The first connecting member 28 may attach to complimentary connectors 34 on the razor cartridge 12 in such a manner that a user may selectively detach the razor cartridge 12 from the neck 14, or, alternatively, in a manner such that, once connected, the razor cartridge 12 and neck 14 are not intended to be separable.

Referring to FIGS. 4 and 4A, the neck 14, in some embodiments, may be detachable from the grip portion 30 of the handle 16. In these embodiments, the neck 14 includes a second connecting member 36 that enables a user to selective detach the neck 14 from the grip portion 30 of the handle 16. As shown in FIG. 4A, the neck 14 includes a “male” press-fit second connecting member 36 that connects with a second complimentary connector 38 on the handle (discussed infra.). However, numerous suitable types of attachments are known to those of skill in the art that could be utilized and, therefore, the second connecting member 36 will not be discussed in greater detail herein. However, it should be noted that, in other embodiments, the neck 14 is integrally formed with the grip portion 30 of the handle 16.

Referring back to FIG. 4, the handle 16 includes a grip portion 30 that is preferably ergonomically shaped, which enables to a user to more comfortably hold the shaving implement 10 of the present invention during use. As mentioned above, the handle 16 may include second complimentary connectors 38 in those embodiments where the neck 14 is selectively removable from the handle 16.

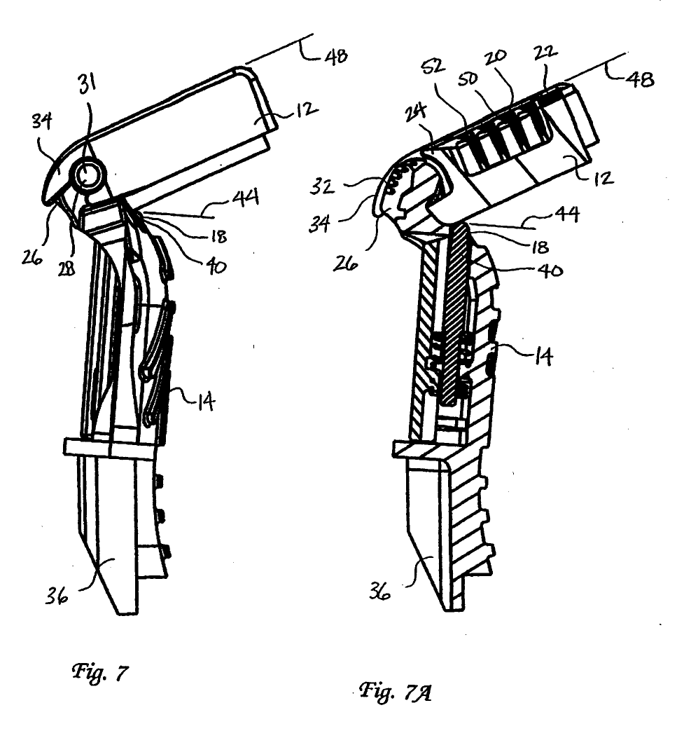

Turning now to FIGS. 6-7A, the biasing member 18 is coupled to the neck 14 and/or the handle 16 and is in contact with the razor cartridge 12. As shown in FIG. 4B, the biasing member 18 can be a spring-loaded plunger 40 that is movable between an extended position 42 (see FIG. 6A) and a retracted position 44 (see FIG. 7A). In these embodiments, an end of the spring-loaded plunger 40 is in contact with the razor cartridge 12 during normal shaving operation. The spring-loaded plunger 40 presses against the razor cartridge 12, urging the razor cartridge 12 toward a neutral position 46 (discussed in greater detail infra.). Although FIGS. 6-7A show the biasing member 18 as a spring-loaded plunger 40, any type of biasing member 18 known to those of skill in the art may be used instead. Common alternatives to the spring-loaded plunger 40 include, but are not limited to, a leaf spring, and a torsional spring.

Alternatively, and although not shown in the FIGS, the biasing member 18 may also be coupled to the razor cartridge 12 without departing from the broader aspects of the present invention. In these embodiments, the biasing member 18 is attached to the razor cartridge 12 and presses against the neck 14 and/or handle 16. In both cases, the biasing member 18 urges the razor cartridge 12 toward the neutral position 46.

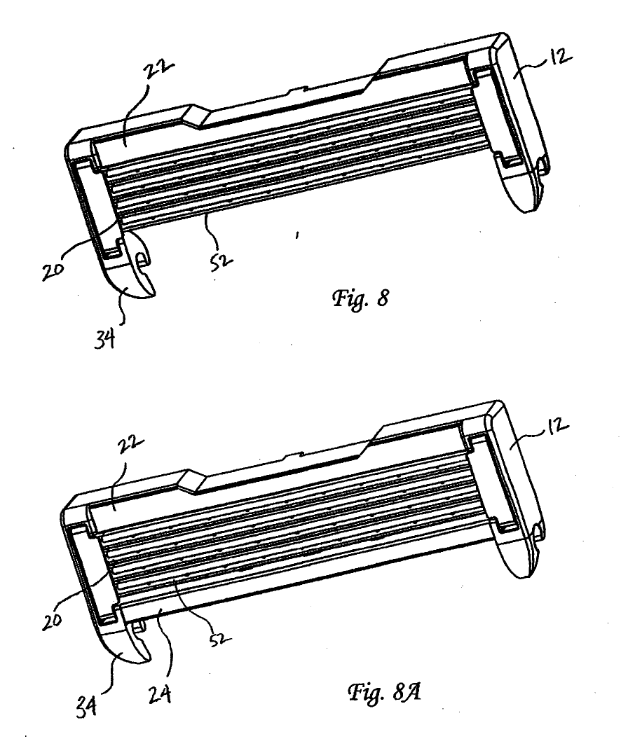

Referring to FIGS. 8-8A, the razor cartridge 12 includes at least one blade 20, a cap 22, and, optionally, a rinse through member 24. In addition, as discussed above, the razor cartridge 12 includes a complimentary connecting member 34 that pivotally connects to the first connecting member 28 of the neck portion 14. As mentioned above, the complimentary connecting member 34 may be “male” or “female” and may have as many connection points as desired. Once connected to the neck 14, the razor cartridge 12 is operable to pivot relative to the handle 16 and the skin-engaging surface 32 of the guard bar 26 between a neutral position 46 (see e.g., FIG. 6) and a rotated position 48 (see e.g., FIG. 7). As shown in FIG. 6, when pivoted toward neutral position 46, the razor cartridge 12 is pivoted relative to the handle 16 (and, accordingly, the skin-engaging surface 32 of the guard bar) toward the surface to be shaved during normal shaving. Conversely, when pivoted toward the rotated position 48, the razor cartridge 12 is pivoted relative to the handle 16 and the skin-engaging surface 32 of the guard bar 26, and away from the surface to be shaved.

At least one blade 20 in the razor cartridge 12 has a sharpened cutting edge 50. Razor blade(s) 20 and their positioning within the razor cartridge 12 are well known to those of skill in the art and, therefore, will not be discussed in greater detail herein. The cap 22 is positioned on the razor cartridge 12 aft of the blade(s) 20 and may include additional elements, such as a comfort strip containing shaving aid (not shown). Caps 22 are also well known to those of skill in the art and, therefore, will not be discussed in greater detail herein either.

As shown in FIG. 8A, some embodiments of the razor cartridge 12 of the present invention may further include a rinse through member 24. In these embodiments, the rinse through member 24 is forward of the blade(s) 20 and is preferably substantially adjacent to the skin-engaging surface 32 of the guard bar 26. As part of the razor cartridge 12, the rinse through member 24 is also pivotable relative to the handle 16 and the skin-engaging surface 32 of the guard bar 26. The rinse through member 24 is set a pre-determined distance from the first blade 52 aft of the skin-engaging surface 32. During use, the rinse through member 24 typically engages the surface being shaved prior to its contact with the first blade 52 aft of the skin-engaging surface 32. By engaging the surface to shaved in the above-described manner, the rinse through member 24 properly orients the surface being shaved as the surface approaches the blade(s) 20. In addition, the rinse through-member 24 is typically shaped to promote rinse-through between itself and the first blade 52 aft of the rinse through member 24, which allows the user to wash away any collected debris.

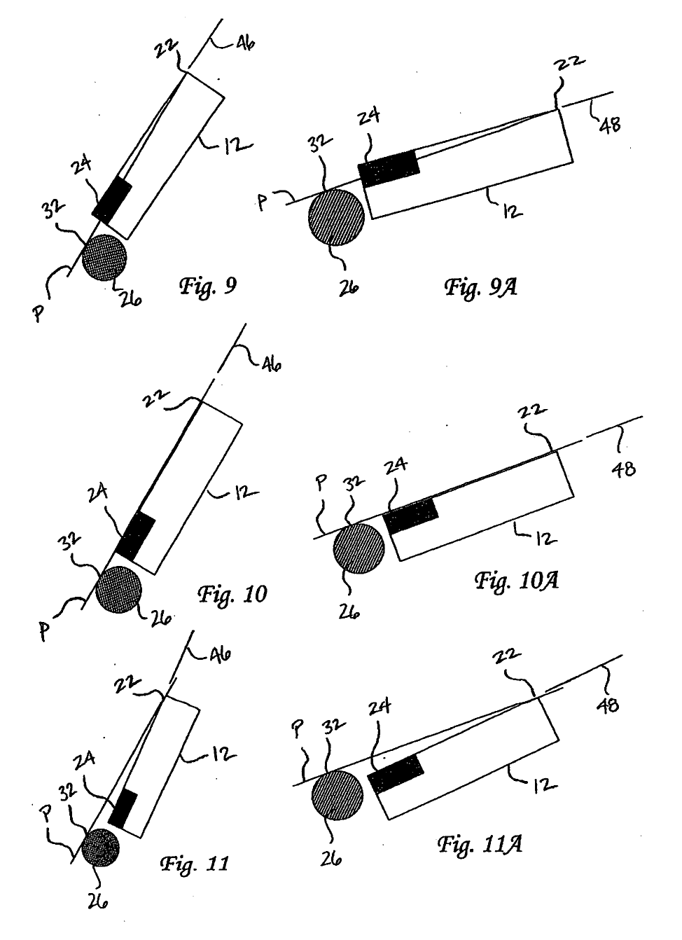

Referring now to FIGS. 9-11A, the rinse through member 24 can be positioned above (FIG. 9), substantially coincident with (FIG. 10), or below (FIG. 11) a plane (“P”). Plane “P” is defined as the plane tangent to the outermost surface of the skin-engaging surface 32 of the guard bar 26 and the outermost portion of the cap 22. During pivotal movement of the razor cartridge 12 between the neutral position 46 and the rotated position 48, the orientation of the rinse through member 32 relative to plane “p” typically remains the same (compare FIG. 9 with FIG. 9A, FIG. 10 with FIG. 10A, and FIG. 11 with FIG. 11A).

Referring back to FIGS. 4-4A, in assembly, the razor cartridge 12, neck 14, and handle 16 are attached such that the neck 14 extends from the handle 16, and the razor cartridge 12 is pivotable relative to the skin-engaging surface 32 of the guard bar 26 on the neck 14. The biasing member 18 urges the razor cartridge 12 toward the neutral position 46.

In operation, and now referring to FIGS. 4-8A, the user brings the assembled shaving implement 10 of the present invention in contact with a surface to be shaved. As the user presses the shaving implement 10 against, and draws the shaving implement 10 along, the surface being shaved, the force of the razor blade(s) 20 cutting hair causes the razor cartridge 12 to pivot relative to the handle 16 toward the rotated position 48. Accordingly, the biasing member 18, in reaction to the forces on the blade(s) 20, urges the razor cartridge 12 back toward the neutral position 46. Meanwhile, the frictional forces caused by the surface being shaved passing over the skin-engaging surface 32 of the guard bar 26 are transferred into the handle 16. In other words, the frictional forces associated with the surface being shaving passing over the skin-engaging surface 32 of the guard bar 26 have a negligible effect on the pivotal movement of the razor cartridge 12 between the neutral and rotated positions 46,48 during normal shaving.

Those skilled in the art will readily appreciate that there are various modifications and adaptations of the precise form of the invention here shown which may suit particular requirements.

What is claimed is:

1. A shaving implement, comprising:
a handle having a grip portion;
a neck extending from the handle, the neck including a first connecting member and a guard bar, the guard bar having a skin-engaging surface portion;
a razor cartridge having a cap positioned aft of at least one blade having a sharpened cutting edge, the razor cartridge being pivotally attached to the first connecting member of the neck such that the razor cartridge is pivotable between a neutral position and a rotated position relative to the skin-engaging surface of the guard bar.

2. The shaving implement of claim 1 further comprising a biasing member coupled to one of the neck or the handle, the biasing member being operable to urge the razor cartridge toward the neutral position.

3. The shaving implement of claim 2, wherein the biasing member is coupled to at least the neck.

4. The shaving implement of claim 2, wherein the biasing member is coupled to at least the handle.

5. The shaving implement of claim 1, wherein the skin-engaging surface of the guard bar is curved.

6. The shaving implement of claim 1, wherein the razor cartridge further comprises a rinse through member forward of the at least one blade, the rinse through member being pivotable with the razor cartridge relative to the skin-engaging surface of the guard bar.

7. The shaving implement of claim 6, wherein the rinse through member is positioned substantially adjacent the skin-engaging surface.

8. A razor handle, comprising:
a grip portion; and
a neck portion having a first connecting member and a guard bar having a skin-engaging surface, the neck portion extending from the grip portion;
wherein the first connecting member is operable to receive a razor cartridge such that the razor cartridge is pivotable relative to the skin-engaging surface of the guard bar.

9. The razor handle of claim 8 further comprising a biasing member coupled to the razor handle, the biasing member being operable to urge the razor cartridge toward the neutral position.

10. The shaving implement of claim 9, wherein the biasing member is coupled to at least the neck.

11. The shaving implement of claim 9, wherein the biasing member is coupled to at least the handle.

12. The razor handle of claim 8, wherein the neck further includes a second connector member and is selectively detachable from the grip portion of the handle.

13. A razor cartridge, comprising:
at least one blade having a sharpened cutting edge;
a cap positioned aft of the at least one blade;
connecting means for attaching to a razor handle having a guard bar such that the at least one blade and cap are pivotable relative to the guard bar.

14. The razor cartridge of claim 13 further comprising a rinse through member positioned forward of the at least one blade, the rinse through member being pivotable with the at least one blade and cap relative to the guard bar.

15. A shaving implement, comprising:
a razor cartridge having at least one blade having a sharpened cutting edge, and a cap positioned aft of the at least one blade; and
a neck having a guard bar, the guard bar having a skin-engaging surface;
wherein the razor cartridge is pivotally connected to the neck such that the razor cartridge pivots relative to the skin-engaging surface of the guard bar.

16. The shaving implement of claim 15, wherein the razor cartridge further includes a rinse through member forward of the at least one blade, the rinse through member being pivotable with the razor cartridge relative to the skin-engaging surface of the guard bar.

17. The shaving implement of claim 15, wherein the neck further includes connecting means for connecting to a handle.

18. A neck for a razor cartridge, comprising:
a guard bar having a skin-engaging surface;
a first connecting member operable to connect with a razor cartridge such that the razor cartridge is pivotable relative to the skin-engaging surface of the guard bar.

19. The neck for a razor cartridge of claim 18 further comprising a second connecting member operable to connect with a razor handle having a grip portion.

20. The neck for a razor cartridge of claim 18 further comprising a biasing member that is operable to urge the razor cartridge toward a neutral position.
